(19) United States
(12) Patent Application Publication
(10) Pub. No.: US 2025/0087084 A1
(43) Pub. Date: Mar. 13, 2025

(54) APPARATUS AND METHOD FOR COORDINATING TRAFFIC FLOW

(71) Applicant: LG ELECTRONICS INC., Seoul (KR)

(72) Inventors: Hyeyoung KIM, Seoul (KR); Minsung KWAK, Seoul (KR); Hakseong KIM, Seoul (KR); Hanbyul SEO, Seoul (KR)

(73) Assignee: LG ELECTRONICS INC., Seoul (KR)

(21) Appl. No.: 18/883,159

(22) Filed: Sep. 12, 2024

(30) Foreign Application Priority Data
Sep. 13, 2023 (KR) 10-2023-0122072

(51) Int. Cl. G08G 1/01

(52) U.S. Cl. CPC G08G 1/0141; G08G 1/0116; G08G 1/0125; G08G 1/0145

(57) ABSTRACT

Proposed is a device for traffic flow coordination, and the device includes a transceiver configured to transmit a traffic flow coordination message to a moving object around a road or to receive traffic flow-related information on the road or surroundings thereof, and a processor configured to process the traffic flow-related information, wherein the processor is configured to obtain the traffic flow-related information, generate maneuver information for at least one moving object based on the obtained traffic flow-related information, and transmit a traffic flow coordination message including the generated maneuver information for the at least one moving object to at least one moving object around the road.

This application claims the benefit of Korean Patent Application No. 10-2023-0122072, filed on Sep. 13, 2023, which is hereby incorporated by reference as if fully set forth herein.

### BACKGROUND

### Field

The present invention relates to an apparatus and method for coordinating a traffic flow, and more particularly, to an apparatus allowing roadside infrastructure such as an RSU (road side unit) to guide a maneuver of a vehicle or a moving object on a road, and a method and a system therefor.

### Discussion of the Related Art

A vehicle may share intent to change a state thereof with a surrounding vehicle using a traffic flow coordination service (Maneuver Sharing Coordinating Service), perform negotiation and coordination, and share a current execution state, thereby contributing to improving road safety and traffic efficiency.

To this end, scenarios utilizing traffic flow coordination messages (Maneuver Sharing Coordinating Messages; MSCMs) are defined in two categories.
Inter-vehicle cooperative lane change
Inter-vehicle cooperative lane merging

An MSCM transmitted by the vehicle includes several pieces of sub-maneuver information and includes the following information.

ManeuverSharingandCoordinatingMessage ::= SEQUENCE {

| mSCMTimestamp | | MsgTimeStamp, |
|---|---|---|
| hVPos | Position3D, | - HV's reference position |

| | |
|---|---|
| hVPosXYConf | PositionalAccuracy, |

| | |
|---|---|
| mSCMType | MSCMType, |

| | |
|---|---|
| sourceID | TemporaryID, |

| | | |
|---|---|---|
| destinationIDs | TemporaryIDList | OPTIONAL, |
| maneuverID | ManeuverID | OPTIONAL, |

| | | |
|---|---|---|
| maneuver | Maneuver | OPTIONAL, |

| | | |
|---|---|---|
| reasonCode | ReasonCode | OPTIONAL, |

| | |
|---|---|
| maneuverExecutionStatus | ManeuverExecutionStatus |

OPTIONAL,

...

```
    }
  Maneuver ::= SEQUENCE {
```

| | |
|---|---|
| maneuverType | ManeuverType, |
| subManeuverList | SubManeuverList, |

```
      ...
    }
  MSCMType ::= ENUMERATED {
```

| | |
|---|---|
| maneuverIntent | (0), |
| maneuverRequest | (1), |
| maneuverResponse | (2), |
| maneuverReservation | (3), |
| hVManeuverCancellation | (4), |
| rVManeuverCancellation | (5), |
| emergencyManeuverReservation | (6), |
| maneuverExecutionStatus | (7), |

```
      }
  SubManeuverList ::= SEQUENCE OF SubManeuver
  SubManeuver ::= SEQUENCE {
```

| | |
|---|---|
| executantID | TemporaryID, |

| | |
|---|---|
| affectedCVIDs | TemporaryIDList, |

| currentStatus | CurrentStatus, | |
|---|---|---|
| targetRoadResource | TargetRoadResource, | OPTIONAL, |

| | | | |
|---|---|---|---|
| StartTime | MsgTimeStamp, | -- | Temporal |

characteristics

| | |
|---|---|
| EndTime | MsgTimeStamp, |

| | | |
|---|---|---|
| minSpeed | Speed OPTIONAL, -- | Kinematic |

characteristics

| | | |
|---|---|---|
| maxSpeed | Speed | OPTIONAL, |

```
      ...
    }
  CurrentStatus ::= SEQUENCE {
```

| | | |
|---|---|---|
| executantPos | PositionOffsetXYZ | OPTIONAL, |

| | |
|---|---|
| executantPosConfidence | PositionConfidenceSet |

OPTIONAL,

| | |
|---|---|
| speed | Speed, |

| | |
|---|---|
| heading | Heading, |
| accel4way | AccelerationSet4Way |

OPTIONAL,

| | |
|---|---|
| size | VehicleSize, |

```
      ...
    }
  PositionOffsetXYZ ::= SEQUENCE {
```

| offsetX | ObjectDistance, | |
|---|---|---|
| offset Y | ObjectDistance, | |
| offsetZ | ObjectDistance | OPTIONAL |

```
      }
  ObjectDistance ::= INTEGER(-32767 .. 32767) -- LSB units of 0.1 meters
  TRRType ::= ENUMERATED {
```

| | |
|---|---|
| TRRType1 | (0), |
| TRRType2 | (1), |
| TRRType3 | (2), |

```
      ...
      }
  TargetRoadResource ::= SEQUENCE {
```

| | |
|---|---|
| tRRType | TRRType, |
| tRRLocation | TRRLocation, |

```
      ...
      }
```

executantID of SubManeuver may include identification information for a vehicle that needs to perform a maneuver according to traffic flow coordination information, and affectedCVID(s) may include identification information for a vehicle affected by the maneuver according to the traffic flow coordination information.

In this specification, traffic flow coordination information includes maneuver information for a vehicle (or a moving object), and maneuver means an operation of movement of the vehicle (or the moving object) including acceleration, deceleration, braking, or steering control, and thus may include lane change, turn, backing up, parking, U-turns, overtaking, emergency avoidance, etc.

FIG. 1 illustrates a basic procedure using the MSCM.

### 1. Pre-Awareness

An HV (host vehicle) and an RV (remote vehicle) enter a maneuver negotiation state through a BSM (basic safety message), an SDSM (Standard Dynamic Spatial Map), and a Maneuver Intent exchange (S10).

### 2. Maneuver Negotiation

The HV transmits a Maneuver Request to all RVs (S20), and the RVs respond with acceptance (S30) or rejection through a Maneuver Response. No new Maneuver Requests are made until the Pre-Awareness state is reached through termination, cancellation, or execution. Upon receiving an acceptance response from an RV, the HV transmits a Maneuver Reservation (S40) to reserve a maneuver performance time.

### 3. Maneuver Execution

The HV and RVs move appropriately according to Maneuver Reservation (S50).

However, simply changing lanes using an MSCM between vehicles cannot prevent traffic accidents or address inefficient traffic flow when a vehicle not supporting autonomous driving is included and when negotiation between vehicles fails.

A vehicle that supports autonomous driving (“autonomous vehicle”) may make a negotiation request to move to a specific location at a specific time, but a non-autonomous vehicle cannot guarantee this, and the non-autonomous vehicle cannot even make a negotiation request to move to a specific location at a specific time. Therefore, traffic flow coordination by a third entity is required to prevent accident risks and efficiently use the road. In addition, since negotiation conditions may differ among autonomous vehicles depending on the implementation algorithm, traffic flow coordination by the third entity is required.

### SUMMARY

The present invention proposes a method for traffic flow coordination and a method therefor.

In addition, the present invention presents new information included in a message for traffic flow coordination.

In addition, the present invention proposes a method of determining entry priority of vehicles (moving objects) in a road section where several lanes merge and conveying this entry priority to the vehicles (moving objects).

In addition, the present invention proposes a method of providing a maneuver guide for a vehicle (moving object) that is entering or is likely to enter a region where passage is restricted.

In addition, the present invention proposes a method of providing a maneuver guide for a vehicle (moving object) that is entering or is likely to enter a region where a temporary obstacle is placed on a road while the vehicle is driven.

The problems to be solved by the present invention are not limited to the problems to be solved above, and other problems not mentioned herein may be clearly understood by a person having ordinary skill in the technical field to which the present invention pertains from the description below.

Proposed is an apparatus for traffic flow coordination. The apparatus includes a transceiver configured to transmit a traffic flow coordination message to a moving object around a road or to receive traffic flow-related information on the road or surrounding thereof, and a processor configured to process the traffic flow-related information, wherein the processor is configured to obtain the traffic flow-related information, generate maneuver information for at least one moving object based on the obtained traffic flow-related information, and transmit a traffic flow coordination message including the generated maneuver information for the at least one moving object to at least one moving object around the road.

Additionally or alternatively, the traffic flow coordination message may include identification information for at least one moving object to be maneuvered according to the generated maneuver information and identification information for at least one moving object affected by a maneuver according to the maneuver information.

Additionally or alternatively, the traffic flow coordination message may include indication information indicating that the maneuver information for the moving object is included.

Additionally or alternatively, the traffic flow coordination message may include information indicating a cause or a reason for generation of the maneuver information for the at least one moving object.

Additionally or alternatively, the cause or the reason may include any one of entry priority guidance to a target road section, avoidance guidance for a driving-restricted road, or obstacle avoidance guidance.

Additionally or alternatively, the traffic flow coordination message may include location information for a region that provided a cause or a reason for generation of the maneuver information for the at least one moving object.

Additionally or alternatively, the processor may be configured to detect a moving object requiring coordination according to maneuver information for at least one moving object to be generated, based on the obtained traffic flow-related information.

Additionally or alternatively, the processor may be configured to determine whether any one of entry priority guidance to a target road section, avoidance guidance for a driving-restricted road, or obstacle avoidance guidance is necessary based on the obtained traffic flow-related information.

Additionally or alternatively, the processor may be configured to arrange maneuver information for each moving object in the traffic flow coordination message in order of entry priorities to the target road section.

Additionally or alternatively, the entry priority may be determined by the processor or determined by an application server.

Additionally or alternatively, the entry priority may be determined based on at least one of whether the moving object is an emergency moving object, whether a lane or road where the moving object was driven before entering the target road section is a priority lane or road, an average driving speed of the lane or road where the moving object was driven, or an expected remaining time to arrive at the target road section.

Additionally or alternatively, the processor may be configured to obtain location information for a region that provided a cause or reason for generation of the maneuver information.

Additionally or alternatively, the processor may be configured to obtain information on a moving object that is likely to enter the target road section or a moving object that has entered or is likely to enter the driving-restricted road or a region where an obstacle is present, and generate a traffic flow coordination message including identification information for the moving object.

Proposed is a method for traffic flow coordination, the method being performed by an apparatus comprising a transceiver configured to transmit a traffic flow coordination message to a moving object around a road or to receive traffic flow-related information on the road or surrounding thereof, and a processor configured to process the traffic flow-related information, the method including obtaining the traffic flow-related information, generating maneuver information for at least one moving object based on the obtained traffic flow-related information, and transmitting a traffic flow coordination message including the generated maneuver information for the at least one moving object to at least one moving object around the road.

The above problem solving methods are only some of the embodiments of the present invention, and various embodiments reflecting the technical features of the present invention may be derived and understood by a person having ordinary knowledge in the relevant technical field based on the detailed description of the present invention described below.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a conventional procedure for traffic flow coordination between vehicles;

FIG. 2 illustrates a block diagram of a system according to the present invention;

FIG. 3 illustrates a situation requiring coordination of entry priority in a target region according to the present invention;

FIGS. 4A and 4B illustrate a flowchart of a procedure for traffic flow coordination related to FIG. 3;

FIG. 5 illustrates a situation requiring guidance for a passage-restricted region according to the present invention;

FIG. 6 illustrates a flowchart of a procedure for traffic flow coordination related to FIG. 5;

FIG. 7 illustrates a situation requiring avoidance guidance for an obstacle region according to the present invention;

FIG. 8 illustrates a flowchart of a procedure for traffic flow coordination related to FIG. 7; and

FIG. 9 illustrates a block diagram of an apparatus for traffic flow coordination according to the present invention.

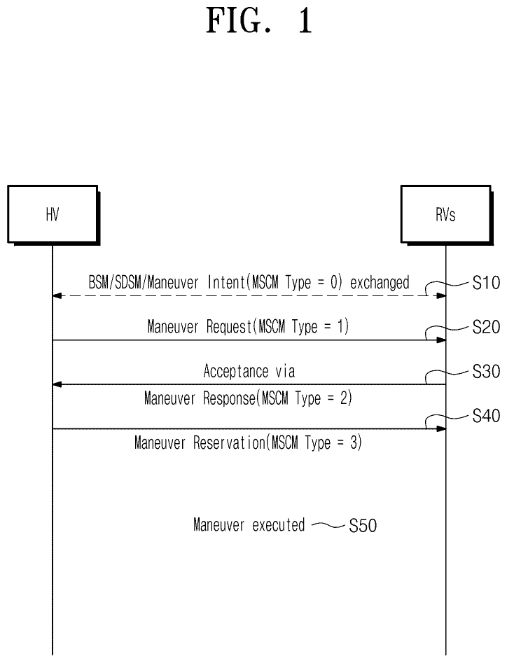

### DETAILED DESCRIPTION

Hereinafter, embodiments of the present invention will be described in detail with reference to the accompanying drawings, and the same or similar components will be given the same reference numerals regardless of reference symbols, and redundant description thereof will be omitted. In the following description, the terms “module” and “unit” for referring to components are assigned and used interchangeably in consideration of convenience of explanation, and thus, the terms per se do not necessarily have different meanings or functions. Further, in describing the embodiments disclosed in the present specification, when it is determined that a detailed description of related publicly known technology may obscure the gist of the embodiments disclosed in the present specification, the detailed description thereof will be omitted. The accompanying drawings are used to help easily explain various technical features and it should be understood that the embodiments presented herein are not limited by the accompanying drawings. As such, the present invention should be construed to extend to any alterations, equivalents and substitutes in addition to those which are particularly set out in the accompanying drawings.

Even though terms including ordinal numbers, such as “first”, “second”, etc., may be used herein to describe various components, the components are not limited by these terms. These terms are generally only used to distinguish one component from another.

When a component is referred to as being “coupled” or “connected” to another component, the component may be directly coupled or connected to the other component. However, it should be understood that another component may be present therebetween. In contrast, when a component is referred to as being “directly coupled” or “directly connected” to another component, it should be understood that there are no other components therebetween.

A singular expression includes the plural form unless the context clearly dictates otherwise.

In this application, it should be understood that a term such as “include” or “have” is intended to designate that the features, numbers, steps, operations, components, parts, or combinations thereof described in the specification are present, and does not preclude the possibility of addition or presence of one or more other features, numbers, steps, operations, components, parts, or combinations thereof.

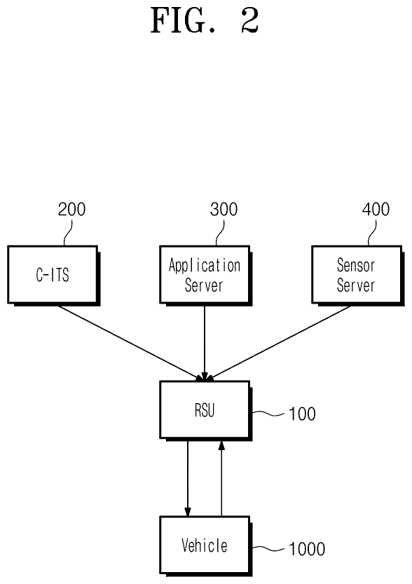

FIG. 2 illustrates a block diagram of a system according to the present invention.

According to the present invention, an RSU 100 may receive traffic flow-related information around the RSU 100 or a specific region from a C-ITS (Cooperative-Intelligent Transport System) 200, an application server 300, and a sensor server 400, process the received information, and transmit a traffic flow coordination message to a vehicle 1000.

In this specification, the vehicle 1000 includes not only an automobile equipped with an autonomous driving function, but also a device capable of moving without such a function such as an automobile, a robot, or a UAM (Urban Air Mobility) aircraft. In this specification, such device capable of moving may be referred to as a “moving object (mobile entity)”.

Meanwhile, the RSU 100 may receive a traffic flow coordination message or content thereof generated based on traffic flow-related information from the application server 300, etc., without receiving traffic flow-related information from the C-ITS 200, the application server 300, the sensor server 400, etc. In this case, the RSU 100 may simply transmit a traffic flow coordination message to the moving object 1000, or may generate a traffic flow coordination message according to the received content and transmit the generated traffic flow coordination message to the moving object 1000. In other words, processing, calculation, etc. for actual traffic flow coordination may be performed in the application server 300, etc.

That is, the RSU 100, the C-ITS 200, the application server 300, the sensor server 400, etc. operate as a single system to process and calculate traffic flow-related information for traffic flow coordination, and generate a message for traffic flow coordination accordingly.

However, for simplicity, in this specification, the RSU is described as performing processing or calculations of traffic flow-related information and transmitting messages.

The present invention proposes a method in which the RSU determines coordination content when it is necessary to determine road entry priority at highway entrances or intersections without traffic lights by receiving location information, road conditions, map information, etc. from a surrounding moving object, a C-ITS center, and an intelligent sensor, or when traffic flow coordination such as lane changes is necessary due to prohibition of entry (avoidance) and detour or departure of a vehicle (or moving object) not allowed to be driven on a restricted road, or a road obstacle and an interfering moving object, generates an MSCM, and then transmits the generated MSCM to the moving object.

Information collectable by the RSU is as follows.
Collect a V2X message (BSM, PSM (personal safety message), etc.) from a surrounding object using V2X communication
Collect location information (latitude, longitude, altitude, speed, heading, and lane) of a detected object (moving object, VRU, obstacle, etc.) from a sensor to create an SDSM.
Collect MAP, SPAT (Single Phase and Timing), TIM (Traveler Information Message), RSA (Road Side Alert), EVA (Emergency Vehicle Alert), traffic laws (priority lane, special road, etc.), and road condition (weather, construction information, etc.) through a V2X message or a specific interface in conjunction with the C-ITS center
Collect road condition and moving object situation information (lighting information of an emergency light and a turn signal) using an intelligent sensor such as a road CCTV and a LiDAR sensor

MAP data refers to data related to detailed information of a road and traffic infrastructure. The MAP data may mainly include information such as vehicles (moving objects), traffic lights, road signs, intersections, lane layout, and road geometry.

The RSU may primarily determine a situation requiring traffic flow coordination using traffic flow-related information (static or dynamic information) below by matching information of surrounding objects mentioned above and location information of a V2X message directly received based on location information (latitude, longitude, and altitude) thereof.
A. Determine traffic flow coordination situation using static information
A.1. Detect an entrance point onto a highway using MAP data (V2X message or similarly defined exchange information)
A.2. Detect an intersection not having a traffic light using MAP data (V2X message or similarly defined exchange information) and SPaT (V2X message or similarly defined exchange information)
A.3. Detect lane reduction using MAP data (V2X message or similarly defined exchange information)
A.4. Detect a special road (a shoulder, a pedestrian-only road, a vehicle (moving object)-only road, etc.) using MAP data (V2X message or similarly defined exchange information) and traffic law information (C-ITS center or similarly defined exchange information).
B. Determine traffic flow coordination situation using dynamic information
B.1. Obtain a location of a road obstacle (fallen object, etc.) using SDSM or an intelligent sensor
B.2. Obtain a location of construction and hazardous regions using road condition information from RSA (roadside alert) or a C-ITS center
B.3. Recognize emergency light information of a moving object using an intelligent sensor and then determine whether it is dangerous
B.4. Recognize a turn signal of a moving object using an intelligent sensor and then determine whether it is dangerous

When a situation requiring traffic flow coordination corresponding to A and B is determined, the RSU may perform the traffic flow coordination as follows.

### 1. Entry Priority Notification

Entry priority may be reported in situations A.1, A.2, and A3.

### 2. Movement Guidance for a Moving Object Violating a Traffic Law

Movement of a moving object violating a traffic law may be guided in situation A.4.

### 3. Lane Movement Guidance

Lane change may be guided in situations B.1, B2, B3, and B.4.

To this end, adding the following fields to the MSCM is proposed.

When the RSU performs traffic coordination, rsuManeuverGuidance is added to MSCMType.

| MSCMType ::= ENUMERATED { | |
|---|---|
| maneuverIntent | (0), |
| maneuverRequest | (1), |
| maneuverResponse | (2), |
| maneuverReservation | (3), |
| hVManeuverCancellation | (4), |
| rVManeuverCancellation | (5), |
| emergencyManeuverReservation | (6), |
| maneuverExecutionStatus | (7), |
| rsuManueverGuidance | (8), |

```
  ...
  }
```

rsuManeuverGuidance may be referred to as guidance information indicating traffic flow coordination information or information indicating that maneuver information for a moving object is included. A moving object receiving an MSCM of MSCM Type=8 may recognize that the corresponding message includes traffic flow coordination information by the RSU.

In addition, the RSU may add TRRType4 to express a location to which the corresponding moving object will move when performing traffic flow coordination. TRRType4 includes length and location information, and may not include lane offset information.

| TRRType ::= ENUMERATED { | |
|---|---|
| TRRType1 | (0), |
| TRRType2 | (1), |
| TRRType3 | (2), |
| TRRType4 | (3), |
| ... | |
| } | |
| TRRLocationType4 ::= SEQUENCE { | |
| tRRLength | TRRLength, |

| | |
|---|---|
| targetPosition | Position3D, |
| laneOffset | LaneOffset OPTIONAL |

}

Lane offset information refers to a relative value of a lane to which a moving object will move as compared to a current lane.

In this way, by providing a new resource type such as TTRType4, it is possible to represent the case where traffic flow coordination is performed by the RSU or other equivalent entities.

Further, adding rsuGuidanceCode to indicate a cause or reason for traffic coordination is proposed. A value of rsuGuidanceCode may be included in the case of MSCMType=8 of the MSCM. rsuGuidanceCode may include any of the following, and other causes or reasons for traffic coordination may be added.

Entry priority notification for a traffic coordination region (or a target road section): entry priority guidance (0)

Avoidance guidance for a driving (passage)-restricted road (special road): restricted road guidance (1)

Obstacle avoidance guidance: obstacle guidance (2)
rsuGuidanceCode ::= ENUMERATED {
entry priority guidance (0),
restricted road guidance (1),
obstacle guidance (2)
}

When the RSU performs traffic flow coordination to transmit a traffic flow coordination message (MSCM) reporting entry priority of a moving object in a traffic coordination region (or a target road section), the message includes a list of one or more SubManeuvers, and the order of the SubManeuvers written in the list may be set as the entry priority.

Each terminal may refer to SubManeuver including the same executantID as temporaryID thereof upon receiving the MSCM transmitted by the RSU.

In addition, in the method proposed in this specification, a recommended location for the movement (maneuver) of the moving object in the MSCM transmitted by the RSU may be indicated using targetRoadResource of subManeuver information, and a location of an intersection, special road, or obstacle causing the movement (maneuver) may be included using affectedRoadResource.

When entry priority for two moving objects is delivered using the MSCM, the message may be structured as follows.

| SubManeuverList ::= SEQUENCE OF SubManeuver | | | |
|---|---|---|---|
| SubManeuver ::= SEQUENCE { | | | |
| executantID | TemporaryID, | | |
| affectedCVIDs | TemporaryIDList, | | |
| currentStatus | CurrentStatus, | | |
| targetRoadResource | TargetRoadResource, | OPTIONAL, | |
| affectedRoadResource | TargetRoadResource, | OPTIONAL, | |
| StartTime | MsgTimeStamp, | -- | Temporal |
| characteristics | | | |
| EndTime | MsgTimeStamp, | | |
| minSpeed | Speed OPTIONAL,-- Kinematic characteristics | | |
| maxSpeed | Speed | OPTIONAL, | |
| ... | | | |
| } | | | |
| SubManeuver ::= SEQUENCE { | | | |
| executantID | TemporaryID, | | |
| affectedCVIDs | TemporaryIDList, | | |
| currentStatus | CurrentStatus, | | |
| targetRoadResource | TargetRoadResource, | OPTIONAL, | |
| affectedRoadResource | TargetRoadResource, | OPTIONAL, | |
| StartTime | MsgTimeStamp, | -- | Temporal |

| characteristics | | |
|---|---|---|
| EndTime | MsgTimeStamp, | |
| minSpeed | Speed OPTIONAL,-- Kinematic characteristics | |
| maxSpeed | Speed | OPTIONAL, |

```
      ...
    }
```

The above indicates that executantID of a first SubManeuver is set to a higher entry priority than that of executantID of a second SubManeuver, and a region causing traffic flow coordination may be indicated by affectedRoadResource.

Referring to A.1, A.2, A.3, A.4, B.1, B.2, B.3, and B.4 described above, the RSU may transmit a traffic flow coordination message to the moving object broadly for three cases. Hereinafter, each case will be described in more detail.

In the following, a description will be given of an embodiment in which the RSU determines a traffic flow coordination situation, determines content of traffic flow coordination (determination of entry priority, lane change, etc.) accordingly, and then create an MSCM to transmit the created MSCM to the moving object or a V2X terminal of the moving object. Meanwhile, as described above, some of the procedures or operations may be performed by the infrastructure, that is, at least one of the C-ITS 200, the application server 300, or the sensor server 400, which falls within the scope of the present invention.

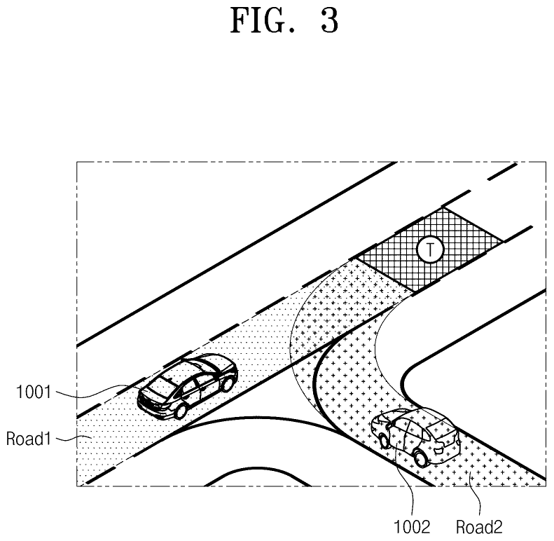

FIG. 3 illustrates a situation requiring coordination of entry priority in a target region (or a target road section) according to the present invention.

FIG. 3 illustrates situations corresponding to A.1, A.2, and A.3 mentioned above.

FIG. 3 illustrates a situation in which determination of entry priority between moving objects and guidance therefor are required for a point T where road 2 joins road 1.

The RSU uses road information obtained from MAP data or road information obtained by the RSU to construct a list of lane-specific coordination-required regions and a coordination target region including a coordination point (entry, intersection, etc.). The coordination target region may include road information associated with each coordination-required region (or coordination point). That is, in the example of FIG. 3, the coordination target region may include information on road 1 and road 2. In this description, the coordination-required region refers to a region excluding a region where road 1 and road 2 of FIG. 3 join each other (that is, excluding coordination point T), and the coordination point T refers to a region where road 1 and road 2 join and overlap.

Upon determining that a moving object enters the coordination-required region or is approaching the coordination point T within a critical distance using location information of a moving object in which a V2X terminal is installed from a received BSM and location information of a moving object in which a V2X terminal is not installed from an SDSM, the RSU may group a list of moving objects for each lane, sort the list in order, and then perform the following procedure.

(1) When a distance between moving object 1 (1001) and moving object 2 (1002) is less than a minimum distance difference based on an expected entry time to the coordination point T, a procedure described below may be continued. That is, it is possible to perform a procedure for determining entry priority for moving objects expected to be located somewhat close to the coordination point T.

(2) A higher priority may be assigned to a special moving object such as an emergency vehicle, and the emergency vehicle may be identified by receiving an EVA message.

(3) When moving objects to be coordinated do not include the special moving object such as the emergency vehicle, and the coordination-required region or the coordination point T includes a priority lane according to traffic laws, a higher priority may be assigned to a moving object driven in the corresponding lane.

(4) When there is no priority lane, an average driving speed of a road (lane) on which moving object 1 is driven and an average driving speed of a road (lane) on which moving object 2 is driven are calculated, and when a difference in average driving speed before a preset point in time based on a determination point in time exceeds a preset speed difference, a higher priority may be assigned to a moving object on a road (lane) having a slower average speed.

(5) Average speeds of the road (lane) on which moving object 1 is driven and the road (lane) on which moving object 2 is driven are calculated, when a difference in average speed before a preset point in time based on a determined point in time is within a preset speed difference, a higher priority may be assigned to a moving object expected to arrive at the coordination point T first.

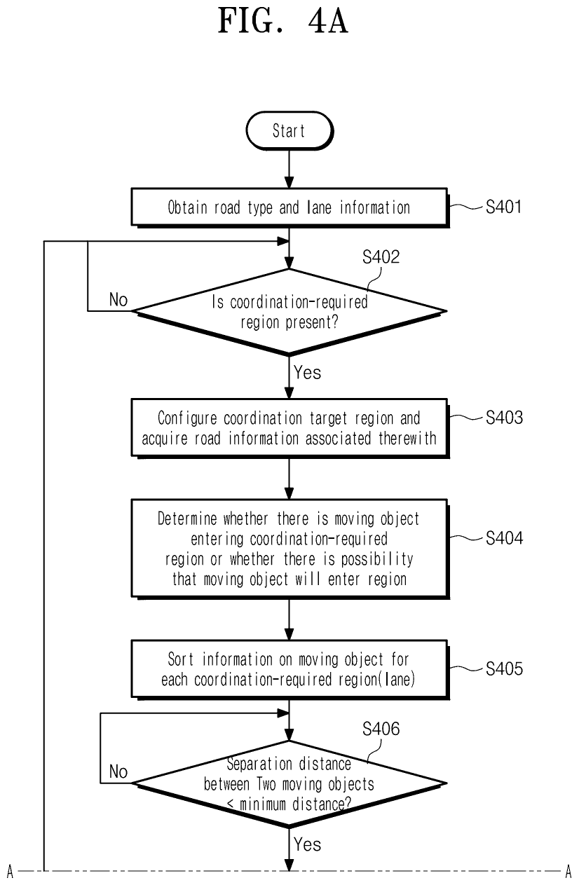

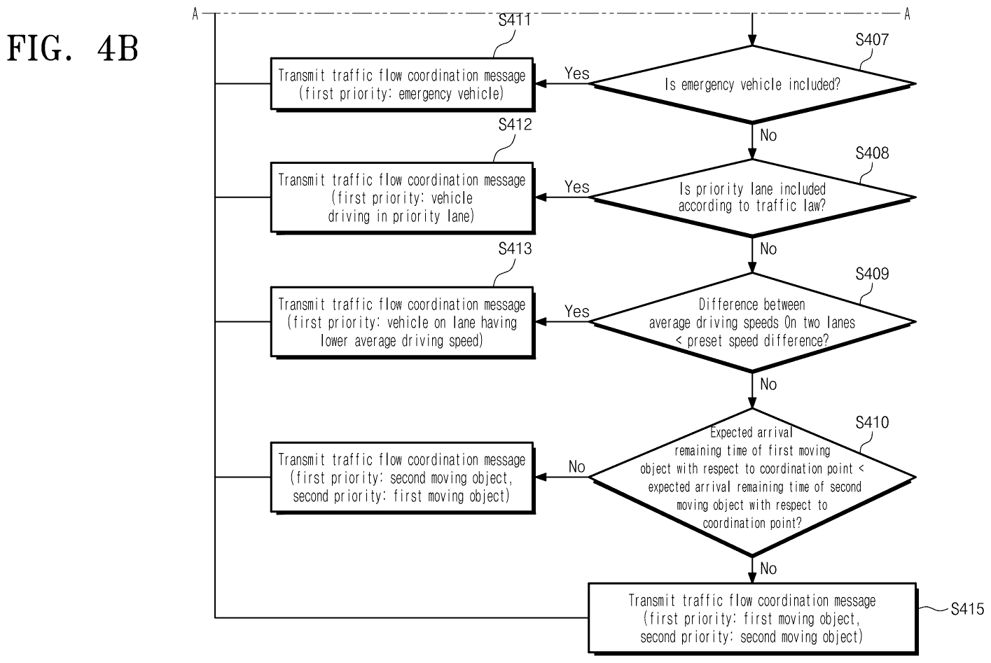

FIGS. 4A and 4B illustrate a flowchart of a procedure for traffic flow coordination related to FIG. 3. The procedure of FIGS. 4A and 4B may be performed by infrastructure around the road such as the RSU 100, and will be simply described below as being performed by a “traffic flow coordination device 100”. In addition, as described above, the operations, functions, or procedures described in this specification may be performed by the RSU 100 or cooperation of at least one of the RSU 100, the application server 300, the C-ITS 200, or the sensor server 400.

The traffic flow coordination device 100 may obtain road type or lane information in a surrounding region (S401). The traffic flow coordination device 100 may obtain the road type or lane information in the surroundings by receiving MAP data from the C-ITS 200, or may obtain the road type or lane information in the surroundings on its own.

The traffic flow coordination device 100 may determine whether a coordination-required region is present from the obtained surrounding road or lane information (S402). For example, when there is a merging or intersecting road in the surroundings, it may be determined that the coordination-required region is present. Alternatively, when an obstacle is placed on the surrounding road, it may be determined that the coordination-required region is present. Upon determining that the coordination-required region is not present, the traffic flow coordination device 100 may determine whether the coordination-required region is present from surrounding road or lane information, which obtained again (S402). S402 may be performed at preset intervals.

The traffic flow coordination device 100 may configure a coordination target region or obtain road information associated with the coordination target region (S403). The coordination target region may include a list of coordination-required regions and a coordination point for each lane. For example, when a cause of the need for coordination is the case where two roads merge, the coordination-required region may be the two roads, and the coordination point T may include a point where the two roads merge and a certain road region thereafter (in a driving direction). In addition, the coordination-required region and the coordination point may be expressed as two-dimensional or three-dimensional coordinate values.

The traffic flow coordination device 100 may determine whether there is a moving object entering the coordination target region or whether there is a possibility that a moving object will enter the coordination target region (S404).

For example, a moving object that is likely to enter the coordination target region may be a moving object driven in the same lane as that of the coordination target region, a moving object driven in a neighboring lane of the coordination target region and turning on a winder in a direction of the coordination target region, etc. In addition, when a distance to the coordination target region is within a critical distance, it is obvious that a driving speed of the corresponding moving object at this time may be considered, and it is possible to determine that there is a high possibility of entering the coordination target region.

The traffic flow coordination device 100 may list or group and sort information on the moving object for each coordination-required region or for each lane/road (S405).

For example, the traffic flow coordination device 100 may list the moving object 1001 traveling on road 1 in the coordination-required region of FIG. 3 as traveling on road 1, and may list and sort the moving object 1002 traveling on road 2 in the coordination-required region of FIG. 3. Although not shown, assuming that there are a following moving object 1003 traveling on road 1 and a following moving object 1004 traveling on road 2, the following list may be generated.

TABLE 1

| | Coordination- | | Moving object |
|---|---|---|---|
| Coordination- | required region (or | Moving object | coordinate |
| required region | lane/road) | information | information |
| ID1 | Road 1 | 1001 | (x1, y1) |
| | | 1003 | (x2, y2) |
| ID2 | Road 2 | 1002 | (x3, y3) |
| | | 1004 | (x3, y3) |

Table 1 may include moving object coordinate information, and may additionally or alternatively include information on the driving speed of the moving object, the average driving speed for the corresponding road or lane, etc.

The traffic flow coordination device 100 may obtain an expected time of entry to the coordination point T for the moving object obtained in S405. In addition, the traffic flow coordination device 100 may compare an expected separation distance between two moving objects based on the obtained expected entry time and determine whether the expected separation distance is smaller than a minimum distance (S406). When the expected separation distance between the two moving objects is smaller than the minimum distance, traffic flow coordination may be required. When the expected separation distance between the two moving objects is equal to or greater than the minimum distance, traffic flow coordination may not be required.

Since FIGS. 4A and 4B relate to guidance of the entry priority, comparison of S406 may be performed for both the two combinational moving objects located in the coordination-required region, lane, or load.

The traffic flow coordination device 100 may verify whether the two moving objects include a special moving object, such as an emergency vehicle, based on the information on the two moving objects obtained in S405 (S407). A higher priority may be assigned to the special moving object such as the emergency vehicle (S411). A reason therefor is to allow the emergency vehicle to rapidly pass through the coordination target region. Therefore, the traffic flow coordination device 100 may transmit a traffic flow coordination message that sets the entry priority of the special moving object such as the emergency vehicle to a first priority and sets the entry priority of the remaining moving object to a second priority.

When the traffic flow coordination target does not include the special moving object such as the emergency vehicle, the procedure proceeds to S408.

The traffic flow coordination device 100 may verify whether a priority lane or priority road is included in the coordination-required region or the coordination point T according to traffic laws (S408). When the coordination-required region or the coordination point T includes the priority lane or priority road according to traffic laws, the traffic flow coordination device 100 may assign a higher priority to a moving object driven in the corresponding lane/road (S412). Therefore, the traffic flow coordination device 100 may transmit a traffic flow coordination message that sets the entry priority of the moving object driven on the priority lane or priority road to a first priority and sets the entry priority of the remaining moving object to a second priority.

When the coordination-required region or the coordination point T does not include the priority lane or priority road according to traffic laws, the procedure proceeds to S409.

The traffic flow coordination device 100 may obtain average driving speeds of roads or lanes where the two moving objects are driven, respectively, and compare a difference between the average driving speeds with a preset speed difference (S409).

When the difference between the average driving speeds of the two roads or lanes is greater than or equal to the preset speed difference, a higher priority may be assigned to a moving object driven on a road or in a lane having a lower average driving speed (S413). A reason therefor is to improve a traffic flow, and to increase the average driving speed of the corresponding lane by assigning a higher priority to a lane having a lower average driving speed. Therefore, the traffic flow coordination device 100 may transmit a traffic flow coordination message that sets the entry priority of the moving object driven on the road or in the lane having the lower average driving speed to a first priority and sets the entry priority of the remaining moving object to a second priority.

When the difference between the average driving speeds of the two roads or lanes is not greater than the preset speed difference, the procedure proceeds to S410.

The traffic flow coordination device 100 may obtain remaining arrival times of the two moving objects with respect to the coordination point T, and compare the remaining arrival times of the two moving objects (S410). A higher priority may be assigned to a moving object having a smaller remaining arrival time (S414 and S415). Therefore, the traffic flow coordination device 100 may transmit a traffic flow coordination message that sets the entry priority of the moving object having the smaller remaining arrival time to a first priority and sets the entry priority of the remaining moving object to a second priority.

S406 to S415 may be performed for both moving objects that may be combined among the moving objects obtained in S405. That is, when an expected separation distance between any two moving objects is less than the minimum distance, a procedure of S407 and subsequent steps may be performed.

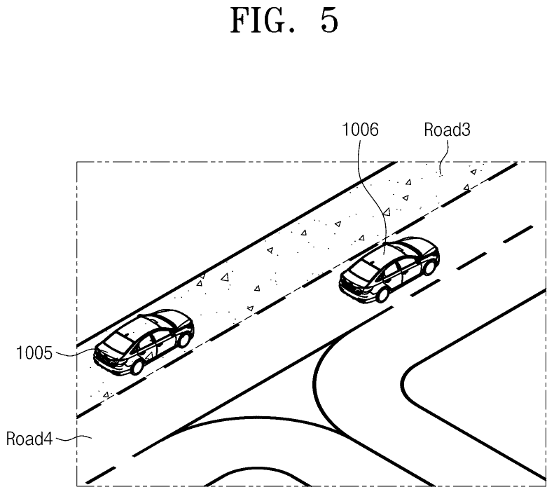

FIG. 5 illustrates a situation requiring guidance for a passage-restricted region according to the present invention.

FIG. 5 illustrates a situation corresponding to A.4 mentioned above.

Referring to FIG. 5, road 3 is set as a special road, and a situation is illustrated where guidance is required for a moving object that cannot be driven on the special road.

The RSU may set a road such as a shoulder, a pedestrian-only road, or a bicycle-only road as the special road using road information obtained from MAP data, traffic law information obtained from the C-ITS center, or road and traffic law information obtained independently.

The RSU may determine a situation requiring guidance by using location information and object information or moving object type information included in a BSM, a PSM, an SDSM, and an EVA message.

(1) Heading information of the BSM/PSM may be used to select a guidance target when a moving object 1005 not suitable for the purpose of the road is driven in the corresponding region, a VRU (vulnerable road user) is entering, or a moving object 1006 that is likely to enter is detected. That is, the guidance target may be selected as follows.
i. A moving object driven in the corresponding lane or on the road
ii. A moving object attempting lane change to the corresponding lane or attempting to enter the corresponding region using the heading information of the BSM
iii. A moving object that turns on a turn signal toward the corresponding lane or road through an intelligent detector

(2) It is possible to guide movement to an available lane (right or left lane or road) along with a cause or reason for traffic flow coordination based on road information held by the RSU

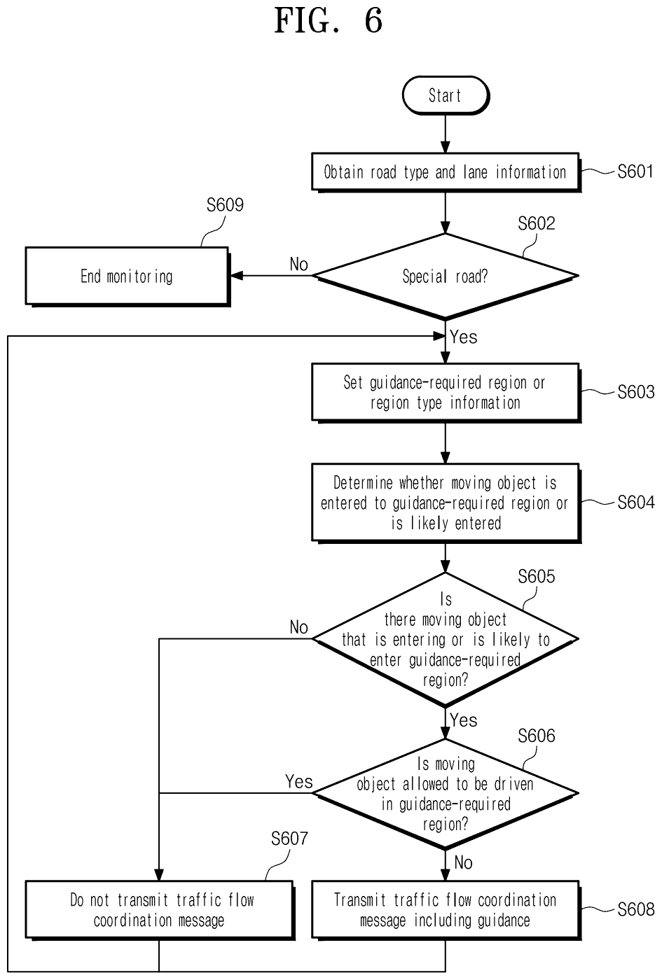

FIG. 6 illustrates a flowchart of a procedure for traffic flow coordination related to FIG. 5. The procedure of FIG. 6 may be performed by infrastructure around a road such as the RSU 100, and will be simply described below as being performed by the “traffic flow coordination device 100”. In addition, as described above, the operations, functions, or procedures described in this specification may be performed by the RSU 100 or cooperation of at least one of the RSU 100, the application server 300, the C-ITS 200, or the sensor server 400.

The traffic flow coordination device 100 may obtain road type or lane information in the surroundings (S601). The traffic flow coordination device 100 may obtain road type or lane information in the surroundings by receiving MAP data from the C-ITS 200, or obtain road type or lane information in the surroundings on its own.

The traffic flow coordination device 100 may determine whether a special road is present in the surroundings (S602). Upon determining that no special road is present in the surroundings, the traffic flow coordination device 100 may suspend a monitoring procedure.

S602 may be performed at preset intervals.

Upon determining that a special road is present in the surroundings, the traffic flow coordination device 100 may set guidance-required region information or type information of a region related thereto (S603). The guidance-required region information may be expressed as two-dimensional or three-dimensional coordinate information. Referring to FIG. 5, the guidance-required region may correspond to road 3. The type information of the region is information corresponding to “rsuGuidanceCode” described above, and may indicate a cause or reason for traffic coordination. For example, the type information of the region may indicate any one of entry priority notification for a traffic coordination region (or target road section), avoidance guidance for a driving (or passage)-restricted road (special road), or obstacle avoidance guidance. According to the example of FIG. 5, the entry priority notification for the traffic coordination region may be indicated.

The traffic flow coordination device 100 may obtain any one of location information (or lane information), object information, or moving object type information included in any one of the BSM, PSM, SDSM, or EVA message. The traffic flow coordination device 100 may determine whether a moving object has entered or is likely to enter the guidance-required region from the obtained information (S604).

The traffic flow coordination device 100 may determine whether there is a moving object that is entering or is likely to enter the guidance-required region (S605). More specifically, when the moving object is driven in the same lane or on the same road as that of the guidance-required region, when the moving object is changing lanes or attempting lane change to a lane corresponding to the guidance-required region, or when the moving object turns on the turn signal toward the lane corresponding to the guidance-required region, it is possible to determine that the moving object has entered or is likely to enter the guidance-required region.

In addition, the traffic flow coordination device 100 may determine whether a moving object that is entering or is likely to enter the guidance-required region, as determined in S605, is a moving object allowed to be driven in the guidance-required region (S606).

The traffic flow coordination device 100 does not transmit a traffic flow coordination message including guidance to a moving object that is allowed to be driven in a guidance-required region (S607).

The traffic flow coordination device 100 may transmit a traffic flow coordination message including guidance for instructing lane movement for a moving object not allowed to be driven in the guidance-required region (S608). In this instance, the traffic flow coordination message may include available lane information or location information thereof, or information indicating a cause or reason for traffic flow coordination (that is, guidance).

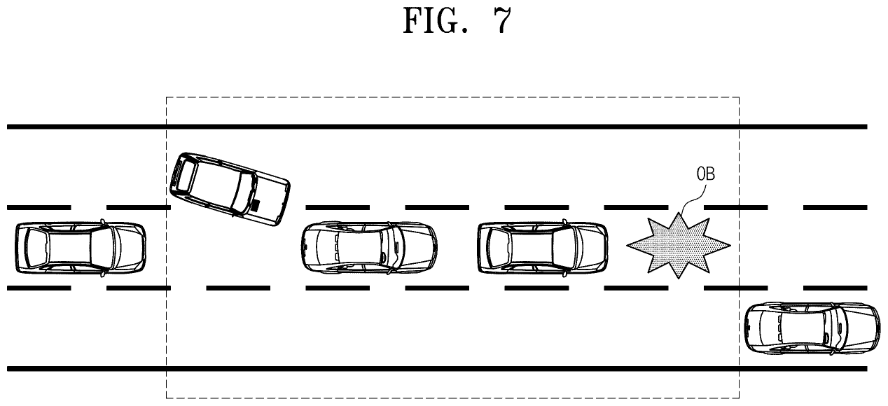

FIG. 7 illustrates a situation requiring avoidance guidance for an obstacle region according to the present invention.

FIG. 7 illustrates situations corresponding to B.1, B.2, B.3, and B.4 mentioned above.

FIG. 7 illustrates a case where an obstacle OB is located in one lane of a road.

The RSU may detect a location of an obstacle or an object on a road by receiving incident detection information, an RSA message, or an SDSM message, or detect a moving object, etc. driven at a low speed or stopped while turning on the emergency light through the intelligent sensor. In this case, the RSU may set the corresponding location to a danger region by collecting location information of the obstacle or the object on the road or the moving object driven at a low speed or stopped while turning on the emergency light. In addition, information indicating an obstacle, delay, or congestion may be set as a type of danger region.

The RSU may perform the following procedure for a moving object approaching a set danger region within a preset threshold distance.

(1) The RSU may distinguish lanes using road information obtained from MAP data or road information obtained by the RSU, and may select a moving object on a road as a guidance target moving object when the moving object corresponds to the following.
i. A moving object approaching a set danger region in the same lane as that of the set danger region
ii. A moving object attempting to change lanes to the corresponding lane using the heading information of the BSM
iii. A moving object turning on a turn signal toward the set danger region through the intelligent detector

(2) The RSU may transmit information on an available adjacent lane (right or left lane) to the guidance target moving object. In this instance, information indicating a cause or reason for guidance may also be transmitted.

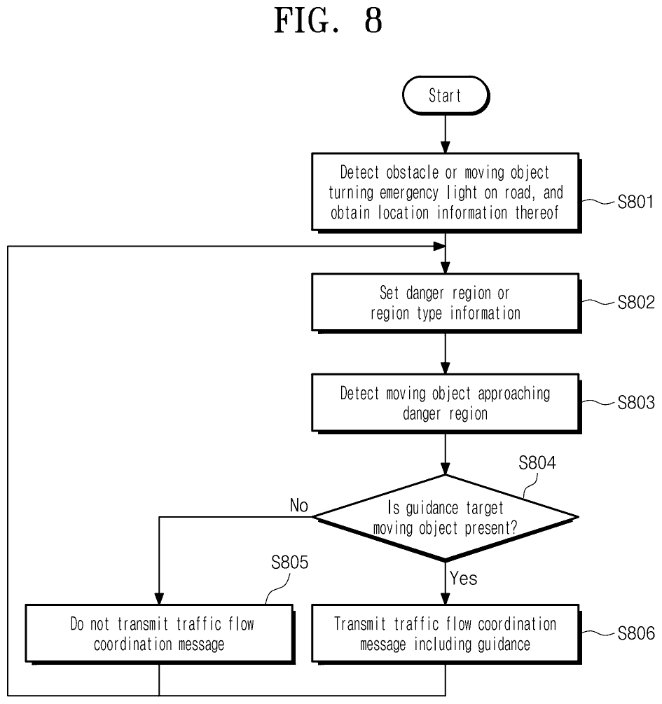

FIG. 8 illustrates a flowchart of a procedure for traffic flow coordination related to FIG. 7. The procedure of FIG. 8 may be performed by infrastructure around a road such as the RSU 100, and will be simply described below as being performed by the “traffic flow coordination device 100”. In addition, as described above, the operations, functions, or procedures described in this specification may be performed by the RSU 100 or cooperation of at least one of the RSU 100, the application server 300, the C-ITS 200, or the sensor server 400.

The traffic flow coordination device 100 may detect an obstacle or a moving object moving at a low speed or stopped while turning on the emergency light on the surrounding road, and obtain location information thereof (S801). To this end, the traffic flow coordination device 100 may use incident detection information and information obtained from an RSA message or an SDSM message.

The traffic flow coordination device 100 may set a danger region corresponding to the location information obtained in S801, or may set type information of the region (S802). The region type information is information corresponding to “rsuGuidanceCode” described above, and may indicate a cause or reason for traffic coordination. For example, the type information of the region may indicate any one of entry priority notification for a traffic coordination region (or target road section), avoidance guidance for a road with a driving (or passage)-restricted (special road), or obstacle avoidance guidance. According to the example of FIG. 7, the obstacle avoidance guidance may be indicated.

The traffic flow coordination device 100 may detect a moving object approaching a set danger region (S803). To this end, the traffic flow coordination device 100 may use information obtained from a BSM received from the moving object. More specifically, location information of the moving object or lane information may be used. The traffic flow coordination device 100 may detect a moving object located within a threshold distance from the set danger region.

The traffic flow coordination device 100 may determine whether a guidance target moving object is present among moving objects approaching the set danger region (S804). More specifically, upon determining that the moving object approaching the danger region approaches the set danger region in the same lane as that of the set danger region, attempts to change lanes to the corresponding lane using heading information of the BSM, or turns on the turn signal toward the set danger region through the intelligent detector, the moving object may be selected as a guidance target moving object.

The traffic flow coordination device 100 may not transmit a traffic flow coordination message when there is no guidance target moving object (S805).

The traffic flow coordination device 100 may transmit a traffic flow coordination message including guidance to the guidance target moving object (S806). In this instance, the traffic flow coordination message may include available lane information or location information thereof, or information indicating a cause or reason for traffic flow coordination (that is, guidance).

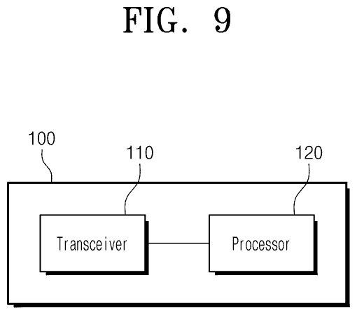

FIG. 9 illustrates a block diagram of an apparatus for traffic flow coordination according to the present invention.

The traffic flow coordination device 100 may include a transceiver 110 configured to transmit a traffic flow coordination message to a moving object around a road or to receive traffic flow-related information on the road and the surroundings.

The traffic flow coordination device 100 may include a processor 120 configured to process the traffic flow-related information.

The processor 120 may obtain traffic flow-related information. In addition, the processor 120 may be configured to generate maneuver information for the moving object based on the obtained traffic flow-related information, and transmit a message including the generated traffic flow coordination information to a moving object around the road. The maneuver information for the moving object may include information for guiding driving of the moving object around the road. For example, the maneuver information for the moving object may include entry priority of a merging road or intersection, lane movement instruction, etc.

Traffic flow-related information may be divided into static information and dynamic information. Static information refers to road information such as MAP data or traffic law information, and dynamic data refers to road accident information obtained through the intelligent sensor.

A message including maneuver information for a moving object may include identification information on a moving object that needs to be maneuvered according to the maneuver information and identification information on a moving object affected by the maneuver according to the maneuver information. In addition, a message including maneuver information for a moving object may include indication information indicating that the maneuver information for the moving object is included.

In addition, a message including maneuver information for a moving object may include information indicating a cause or reason for generation of the maneuver information for the moving object. That is, a message including maneuver information for a moving object may include information indicating a cause or reason for traffic flow coordination.

Generation of maneuver information for a moving object or a cause or reason for traffic flow coordination may include any one of entry priority guidance to a target road section, avoidance guidance for a driving-restricted road, or obstacle avoidance guidance.

In addition, a message including maneuver information for a moving object may include location information for a region (or road or lane) serving as a cause or reason for generation of the maneuver information for the moving object or traffic flow coordination. Here, the location information may include identification information of the road or two-dimensional or three-dimensional location coordinate information of the road.

The processor 120 may be configured to detect a moving object requiring coordination according to the maneuver information for the moving object based on the obtained traffic flow-related information.

The processor 120 may be configured to determine whether any one of entry priority guidance to a target road section (that is, the coordination point T of FIG. 3), entry avoidance guidance for a driving-restricted road (that is, road 3 of FIG. 5), or obstacle avoidance guidance is required based on the obtained traffic flow-related information.

As a method of transmitting the entry priority to the target road section, the processor 120 may be configured to arrange maneuver information for each moving object in the message in the order of the entry priority to the target road section. That is, the message may include maneuver information for a plurality of moving objects, and each piece of maneuver information corresponds to information for an individual moving object. In addition, each moving object may control driving thereof by referring to the maneuver information for the moving object.

The entry priority to the target road section may be determined by the processor or by the application server.

Here, the entry priority may be determined based on at least one of whether an emergency moving object is present in the lane or on the road on which the moving object is driven, whether the lane or road where the moving object is driven is a priority lane or road before entering the target road section, an average driving speed of the lane or road where the moving object is driven, or an expected remaining time to arrive at the target road section.

The processor 120 may be configured to obtain location information for a region (for example, a road or a lane) serving as a cause or reason for generation of maneuver information. The location information may be expressed as two-dimensional or three-dimensional coordinate information.

The processor 120 may be configured to obtain information on a moving object that is likely to enter the target road section or a moving object that is entering the driving-restricted road or a region where an obstacle is present or is likely to enter the driving-restricted road or the region. In addition, the processor 120 may be configured to generate a message including identification information for the moving object.

Even though not described with reference to FIG. 9, the operations, functions, or procedures of the present invention described with reference to FIGS. 2 to 8 may be performed by the apparatus for traffic flow coordination of FIG. 9.

The present invention has the following effects.

The present invention may provide an apparatus for traffic flow coordination and a method therefor.

In addition, the present invention presents new information included in a message for traffic flow coordination and may control or manage a traffic flow while omitting negotiation between vehicles (moving objects).

In addition, the present invention determines entry priority of a vehicle (moving object) in a road section where several lanes merge, and transmits the entry priority to vehicles (moving objects), so that a smooth traffic flow may be expected.

In addition, the present invention may provide maneuver guidance for vehicles (moving objects) to a vehicle (moving object) that is entering or is likely to enter a passage-restricted region, thereby preventing driving of the vehicle (moving object) in the passage-restricted region.

In addition, when a temporary obstacle is placed on a road on which the vehicle is driven, the present invention provides maneuver guidance for vehicles (moving objects) to a vehicle (moving object) that is entering or is likely to enter this region, so that a smooth traffic flow may be expected.

The effects according to the present invention are not limited to the effects mentioned above, and other effects not mentioned herein will be clearly understood by those skilled in the art from the above detailed description of the invention.

What is claimed is:

1. An apparatus for traffic flow coordination, the apparatus comprising:
a transceiver configured to transmit a traffic flow coordination message to a moving object around a road or to receive traffic flow-related information on the road or surroundings thereof; and
a processor configured to process the traffic flow-related information,
wherein the processor is configured to:
obtain the traffic flow-related information,
generate maneuver information for at least one moving object based on the obtained traffic flow-related information, and
transmit a traffic flow coordination message including the generated maneuver information for the at least one moving object to at least one moving object around the road.

2. The apparatus according to claim 1, wherein the traffic flow coordination message includes identification information for at least one moving object to be maneuvered according to the generated maneuver information and identification information for at least one moving object affected by a maneuver according to the maneuver information.

3. The apparatus according to claim 1, wherein the traffic flow coordination message includes indication information indicating that the maneuver information for the moving object is included.

4. The apparatus according to claim 1, wherein the traffic flow coordination message includes information indicating a cause or a reason for generation of the maneuver information for the at least one moving object.

5. The apparatus according to claim 4, wherein the cause or the reason includes any one of entry priority guidance to a target road section, avoidance guidance for a driving-restricted road, or obstacle avoidance guidance.

6. The apparatus according to claim 1, wherein the traffic flow coordination message includes location information for a region that provided a cause or a reason for generation of the maneuver information for the at least one moving object.

7. The apparatus according to claim 1, wherein the processor is configured to detect a moving object requiring coordination according to maneuver information for at least one moving object to be generated, based on the obtained traffic flow-related information.

8. The apparatus according to claim 1, wherein the processor is configured to determine whether any one of entry priority guidance to a target road section, avoidance guidance for a driving-restricted road, or obstacle avoidance guidance is necessary based on the obtained traffic flow-related information.

9. The apparatus according to claim 8, wherein the processor is configured to arrange maneuver information for each moving object in the traffic flow coordination message in order of entry priorities to the target road section.

10. The apparatus according to claim 8, wherein the entry priority is determined by the processor or determined by an application server.

11. The apparatus according to claim 8, wherein the entry priority is determined based on at least one of whether the moving object is an emergency moving object, whether a lane or road where the moving object was driven before entering the target road section is a priority lane or road, an average driving speed of the lane or road where the moving object was driven, or an expected remaining time to arrive at the target road section.

12. The apparatus according to claim 8, wherein the processor is configured to obtain location information for a region that provided a cause or reason for generation of the maneuver information.

13. The apparatus according to claim 8, wherein the processor is configured to:
obtain information on a moving object that is likely to enter the target road section or a moving object that has entered or is likely to enter the driving-restricted road or a region where an obstacle is present, and
generate a traffic flow coordination message including identification information for the moving object.

14. A method for traffic flow coordination, the method being performed by an apparatus comprising a transceiver configured to transmit a traffic flow coordination message to a moving object around a road or to receive traffic flow-related information on the road or surrounding thereof, and a processor configured to process the traffic flow-related information, the method comprising:
obtaining the traffic flow-related information;
generating maneuver information for at least one moving object based on the obtained traffic flow-related information; and
transmitting a traffic flow coordination message including the generated maneuver information for the at least one moving object to at least one moving object around the road.

15. A computer-readable medium storing a computer program configured to perform a method for traffic flow coordination comprising obtaining the traffic flow-related information, generating maneuver information for at least one moving object based on the obtained traffic flow-related information, and transmitting a traffic flow coordination message including the generated maneuver information for the at least one moving object to at least one moving object around the road.
